(19) United States
(12) Patent Application Publication
(10) Pub. No.: US 2021/0185928 A1
(43) Pub. Date: Jun. 24, 2021

(54) MOWER COMBINATION

(71) Applicant: AGCO International GmbH, Neuhausen (CH)

(72) Inventors: Johannes Fillep, Feucht (DE); Ronnie Kinast, Ilschwang (DE)

(21) Appl. No.: 17/128,060

(22) Filed: Dec. 19, 2020

(30) Foreign Application Priority Data
Dec. 19, 2019 (GB) 1918845.7

(51) Int. Cl. A01D 57/20; A01D 43/077; A01D 34/64

(52) U.S. Cl. CPC A01D 57/20; A01D 2101/00; A01D 34/64; A01D 43/077

(57) ABSTRACT

A mower combination including an agricultural vehicle and a number of mowing units suitable for cutting a standing crop connected to the agricultural vehicle, including a front mowing unit and two lateral mowing units located behind and to the sides of the front mowing unit, each of the lateral mowing units having conveyor units to deposit cut crop as a swath. The mower combination additionally includes a control unit which receives a plurality of signals representing unprocessed crop boundary data, field boundary data, and data relating to the lateral displacement of each of the lateral mowing units. The control unit compares the signals against a predetermined target set of values and adjusts the lateral displacement of at least one conveyor unit based on this comparison. This allows for production of repeatedly uniform tapers of a desired configuration.

### CROSS REFERENCE TO RELATED APPLICATION

This application claims the benefit of U.K. Application No. GB 1918845.7, filed Dec. 19, 2019, which is hereby incorporated by reference in its entirety.

### BACKGROUND

### Field

The present invention relates to a mower combination comprising an agricultural vehicle and a number of mowing units suitable for generating swathes of cut crop, and in particular to a mowing apparatus for cutting a standing crop such as hay.

### Description of Related Art

It is known to provide a mower combination in which a first mower unit is located ahead of an agricultural vehicle such as a tractor with two further lateral mower units trailing the agricultural vehicle. The rear mower units can be provided with conveyor units for depositing cut crop into a swath or swathes behind the agricultural vehicle.

It is known for an operator to cause the conveyors units to be displaced from a normal working position such that a taper is provided at the start or end of a swath. This is because it is desirable that a swath should be as compact as possible at the ends.

However, the need to constantly monitor and adjust the settings of the conveyor units throughout the working of multiple swaths over a number of fields of varying shapes and sizes is stressful and tiring for the operator of the mower combination.

### SUMMARY

According to a first aspect of the present invention, a mower combination comprises an agricultural vehicle and a number of mowing units suitable for cutting a standing crop connected to the agricultural vehicle, including a front mowing unit and two lateral mowing units located behind and to the sides of the front mowing unit, each of the lateral mowing units being provided with conveyor units to deposit the cut crop as a swath, the mower combination further comprising a control unit receiving a plurality of signals, the signals representing unprocessed crop boundary data, field boundary data, and data relating to the lateral displacement of each of the lateral mowing units, the control unit being configured to receive the plurality of signals and compare the signals for the unprocessed crop boundary data, the field boundary data and the data relating to the lateral displacement of each of the conveyor units against a predetermined target set of values and to adjust the lateral displacement of at least one conveyor unit based on this comparison to taper the swath in a predetermined manner when commencing or concluding depositing the cut crop as the swath.

This has as an advantage that the lateral displacement of the conveyor units can be altered to allow for production of repeatedly uniform tapers of a desired configuration.

Further, this also has as an advantage that the operator no longer needs constantly to monitor the operation of the conveyor units thereby reducing the stress and tiredness of the operator.

Preferably, the signals representing unprocessed crop boundary data are provided by one or more sensors located on the front mower unit or the agricultural vehicle. Alternatively or additionally, the signals representing unprocessed crop boundary data are provided by one or more sensors located on the lateral mowing units.

Preferably, the sensors include optical sensors, or GPS apparatus.

Preferably the control unit receives signals representing aspects of the agricultural vehicle. More preferably the control unit receives signals corresponding to an orientation of a longitudinal axis of the agricultural vehicle and/or a speed of the agricultural vehicle.

According to a second aspect of the invention, a computer implemented method comprises the steps of receiving a plurality of signals, the signals representing unprocessed crop boundary data, field boundary data, and data relating to a lateral displacement of each of two lateral mowing units, the control unit being configured to receive the plurality of signals and compare the signals for the unprocessed crop boundary data, the field boundary data and a lateral displacement of one or more of the lateral mowing units against a predetermined set of target values and to adjust the lateral displacement of at least one lateral mowing unit based on this comparison.

According to a third aspect of the present invention, a computer readable program comprises instructions that causes one or more processors to implement the method of the second aspect of the invention.

### BRIEF DESCRIPTION OF THE DRAWINGS

The invention will now be described, by way of example only, with reference to the accompanying drawings, in which:

FIG. 1 shows a plan view of a mower combination for use in the present invention;

FIG. 2 shows a schematic view of elements of a mower combination for use in the present invention;

FIG. 3a shows a view similar to FIG. 1 showing formation of a swath as the mower combination approaches the end of a blunt headland or field boundary;

FIG. 3b shows a view similar to FIG. 3a showing formation of the swath following lateral displacement of the conveyor units;

FIG. 4 shows a flow diagram illustrating an example control method for the swath formation of FIGS. 3a and 3b;

FIG. 5a shows a view similar to FIG. 1 showing formation of a swath as the mower combination approaches the end of an angled headland or field boundary;

FIG. 5b shows a view similar to FIG. 5a showing formation of the swath following lateral displacement of one of the conveyor units and prior to the displacement of the other of the conveyor units; and

FIG. 6 shows a flow diagram illustrating an example control method for the swath formation of FIGS. 5a and 5b.

### DETAILED DESCRIPTION OF SPECIFIC EMBODIMENTS

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

Reference to terms such as longitudinal, transverse and vertical are made with respect to a longitudinal vehicle axis which is parallel to a normal forward direction of travel.

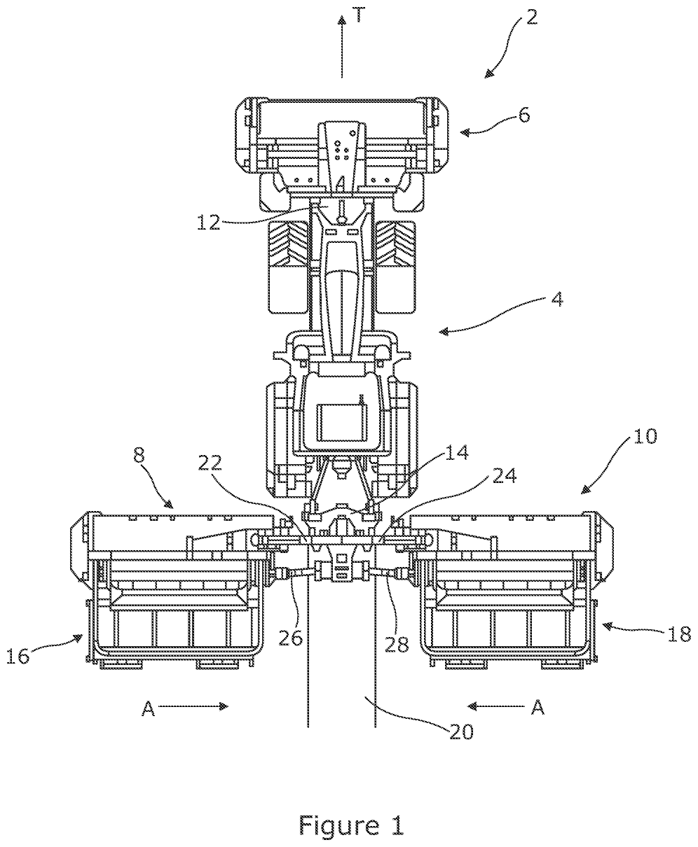

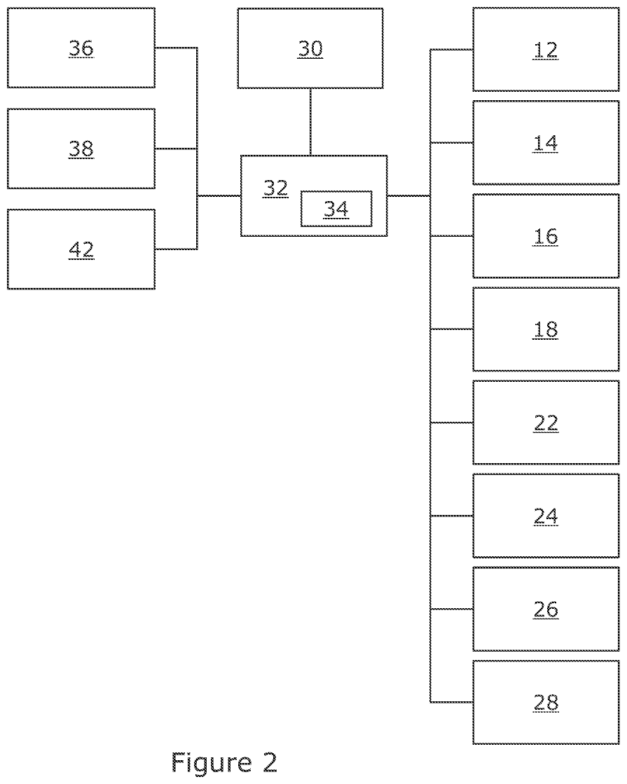

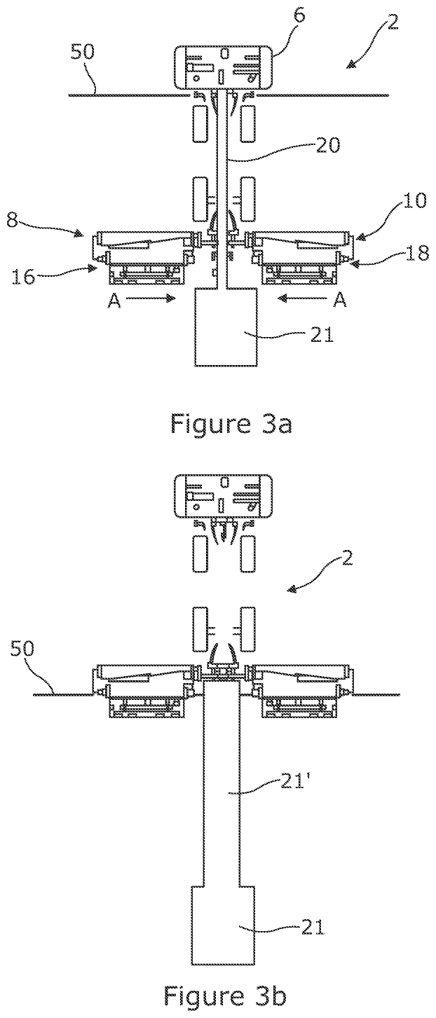

With reference first to FIGS. 1 and 3a, a plan view of a mower combination 2 for use in the present invention is shown. (For reasons of clarity, substantially only the wheels of the agricultural vehicle are shown in FIGS. 3a,3b and 5a,5b).

A mower combination 2 comprises an agricultural vehicle 4 such as a tractor and a number of mowing units 6,8,10 suitable for cutting standing crop, the mowing units 6,8,10 being connected to the agricultural vehicle. The mowing units include a front mowing unit 6 located to the front of the agricultural vehicle 4 and two lateral mowing units 8,10 located behind and to the sides of the agricultural vehicle 4, each of the mowing units 6,8,10 being adapted to cut crop. The front mowing unit 6 is conveniently mounted on a front hitch 12 of the agricultural vehicle 4. The two lateral mowing units 8,10 are conveniently mounted on a central chassis supported from a rear hitch 14 of the agricultural vehicle 4.

The lateral mowing units 8,10 are supported from a central chassis by hydraulic apparatus 22,24. Each hydraulic unit 22,24 may be used to move a respective lateral mowing unit 8,10 from a working position to a transport position. A headland position may be defined between the working position and the transport position. In the working position the height of each of the lateral mowing units 8,10 above the ground surface may be further controlled by operation of the hydraulic apparatus 22,24.

In the illustrated embodiment of FIG. 1 a swath 20 produced by the front mowing unit 6 is shown. In practice conveyor units 16,18 mounted to the rear of the lateral mowing units 8,10 are adapted to direct the deposit of cut crop material to one side or the other of the respective lateral mowing units 8,10 to produce a broader central swath 21 or one or more additional swathes as desired (cf FIGS. 3a,5a). For clarity, these swathes are omitted from FIG. 1.

The conveyor units 16,18 are mounted to be displaceable with respect to the lateral mowing units 8,10. The conveyor units may be displaced by hydraulic apparatus 26,28 or other suitable apparatus. The conveyor units 16,18 are mounted to be displaced (arrows A in FIGS. 1 and 3a) in a direction lateral to a direction of travel (arrow T in FIG. 1) of the mower combination 2.

The conveyor units 8,10 can comprise conveyor belts or conveyor screws.

An operator can control operation of the front and rear mowing units 6,8,10 from within the agricultural vehicle 4 by use of a suitable user terminal 30. For example the operator can control the lateral displacement of the conveyor units, can cause each of the mowing units 6,8,10 to move from a working position to a headland position, can cause the rear mowing units 8,10 to move from the working position to a transport position, or can cause the conveyor units 16,18 to move from an active position to an inactive position.

The user terminal 30 communicates with an electronic control unit 32. The control unit 32 may provide signals to control operation of the front and rear hitches 12,14 of the agricultural vehicle 4 and provides signals to control operation of the mowing units 6,8,10 and the conveyor units 16,18 eg to control the lateral displacement of the conveyor units 16,18. Conveniently the signals are provided by way of a suitable data communication network such as one compliant with the ISOBUS standard (a network in conformance to ISO 11783).

The control unit 32 may conveniently comprise a single processor located on the agricultural vehicle or its functions may be split between a processor located on the agricultural vehicle and one or more additional processors located on the mowing units 6,8,10, the additional processor(s) being in electronic communication with the first processor.

The control unit 32 is also able to access a suitable memory 34. The memory 34 may take any suitable form and is in electronic communication with the control unit 32. The memory 34 is adapted to store, in any suitable manner such as a database or look up table, reference values for a desired lateral displacement of the conveyor units 16,18 in the presence or absence of unprocessed crop ahead of the mower combination.

The mower combination 2 further comprises a plurality of sensors adapted to provide input signals to be received by the control unit 32. An input signal representing the presence of an unprocessed crop boundary is provided. The presence or absence of unprocessed crop can be provided by a suitable sensor or sensors 36. In a preferred embodiment, the sensor is provided on the front mower unit 6 or the agricultural vehicle 4. Any suitable sensor may be utilised, including for example a camera.

Alternatively the input signal could be provided as a result of information provided by a GPS sensor, for example the location of the mower combination 2 may be known or calculated from existing mapped data allowing the control unit 32 to determine whether the location to be traversed has previously been processed and accordingly whether crop in front of the mower combination has been or is yet to be processed and accordingly, the relative location of both the unprocessed crop boundary and the field boundary.

In the case of a GPS sensor, it will be understood that a network interface 42 connected to the control unit 32 is provided. The network interface 42 can comprise hardware and/or software that enables wireless connection to one or more remotely located computing devices over a network (e.g., a wireless or mixed wireless and wired network). For instance, the network interface 42 may cooperate with browser software or other software of the control unit 30 to communicate with a server device, enabling remote monitoring or control of the mower combination 2.

The GPS sensor may also be sued to provide an input signal representative of the location of the field boundary (including the location of the headland). Alternatively the data relating to the field boundary may be downloaded by way of the network interface 42 or otherwise signalled to the control unit 32 before commencing operation of the mower combination.

Suitable sensors 38 mounted on the mower combination 2, for example on the conveyor units 16,18 can provide input signals representative of the lateral displacement of the conveyor units 16,18. The lateral displacement may be measured from any suitable reference point.

The control unit 32 is configured to receive the input signals representing the presence or absence of unprocessed crop and the lateral displacement of the conveyor units 16,18 and to compare the input signals with the reference values for a reference lateral displacement of the conveyor units 16,18 and, as required, adjust the lateral displacement of at least one conveyor unit 16,18 based on this comparison.

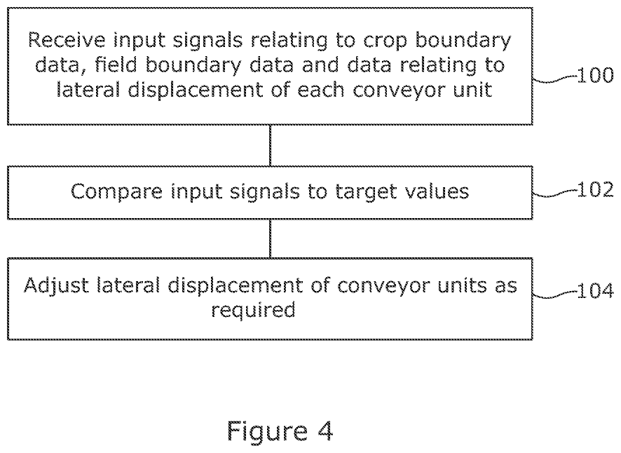

For example as the mower combination 2 traverses a field having a blunt headland 50 (FIG. 3a), for example at the end of a rectangular field, the control unit 32 receives signals indicating that the unprocessed crop boundary is approaching the field boundary and a current lateral displacement of the conveyor units 16,18 (step 100, FIG. 4). Based on a comparison of the input signals with the reference target values stored in the memory 34 (step 102), the control unit 32 causes the lateral displacement of each of the conveyor units 16,18 to be adjusted (step 102). The mower combination will then create a swath of narrower width 21′ as it traverses the final section of unprocessed crop ahead of the headland region (FIG. 3b) and the unprocessed crop boundary meets the field boundary. The control unit 32 can then cause the rear mowing units 8,10 (and the associated conveyors 16,18) to adopt a headland position.

On the return run, the control unit 32 receives signals indicating the field boundary. The control unit 32 lowers the rear mowing units 8,10 from the headland position to a working position to meet the field boundary. The control unit 32 then receives signals indicating that the unprocessed crop boundary is moving away from the field boundary. Based on a comparison of the input signals with the reference values stored in the memory 34, after depositing the cut crop as a swath of relatively narrow width on the initial cutting of the unprocessed crop away from the field boundary, the control unit 32 then causes the lateral displacement of each conveyor unit 16,18 to be adjusted outward such a that the cut crop is deposited as a swath of regular width.

The control unit 32 may also receive signals indicative of the speed of the agricultural vehicle allowing the control unit 32 a further means of determining the relative position of the mower combination from the field boundary and to adjust the lateral displacement of at least one conveyor unit.

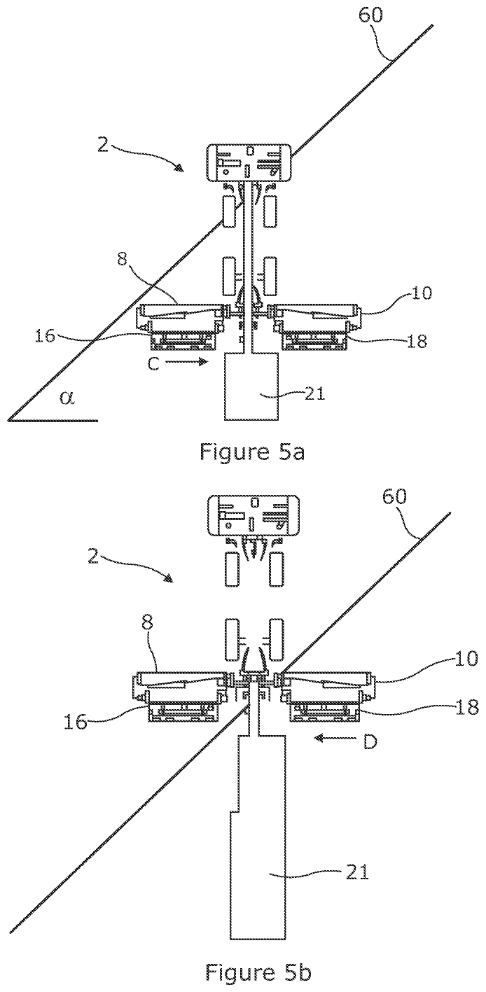

FIGS. 5a and 5b illustrate a common situation, namely that of an angled headland or field boundary 60. In such a situation the control unit 30 based upon the input signals will determine that the unprocessed crop interface varies to the left and to the right of the mower combination.

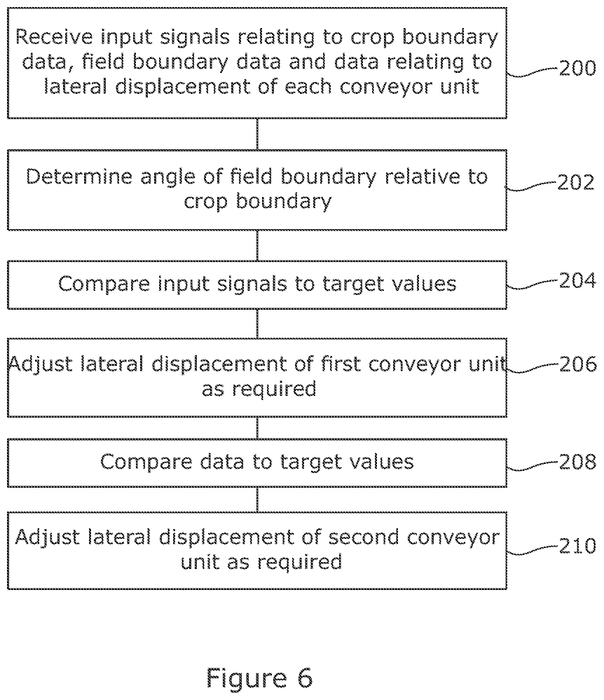

As in the example of FIGS. 3a and 3b, the control unit 32 receives signals indicating that the unprocessed crop boundary is approaching the field boundary and a current lateral displacement of the conveyor units 16,18 (step 200, FIG. 6). The control unit 32 is able to determine an angle α (in FIGS. 5a and 5b running from left to right) between the field boundary 60 and the crop boundary (step 202, FIG. 6). Based on a continuous comparison of the input signals (and so the angle α) with the reference values stored in the memory 34 (steps 204,208), the control unit 32 causes the lateral displacement of a first conveyor unit 16 to be adjusted (step 206, FIG. 6)—in FIG. 5a the left hand conveyor unit (arrow C)—and then subsequently the lateral displacement of a second conveyor unit 18 (step 220 FIG. 6) in FIG. 5b the right hand conveyor unit (arrow D).

Alternatively, the control unit 30 determines on the basis of signals from the sensors 36 a first crop boundary location ahead of a first lateral mower unit and its associated conveyor unit and a second crop boundary location ahead of the second lateral mower unit and its associated conveyor unit. Based upon the comparison of the input signals with the reference values stored in the memory 34, the control unit 32 causes the lateral displacement of each of the conveyor units in turn.

In other embodiments, the control unit 32 may receive input from the user terminal 30, as entered by the operator. For instance, the operator may prompt a display of the parameters (the distance to or from an unprocessed crop interface to a field boundary, the lateral displacement of the conveyor units 16,18). The control unit 32 provides the corresponding information for rendering on a display screen in the agricultural vehicle 4. Additionally or alternatively the control unit 32 may provides the corresponding information for rendering on a display screen remote from the agricultural vehicle 4.

Additionally, the operator may use the user terminal 32 to configure the width of a tapered swath and or the length of the swath of reduced width as desired.

In some embodiments, the control unit 32 may provide feedback of the automatic adjustment in the lateral position of the conveyor units 16,18 to the operator via the user terminal 30, for example visually or audibly.

From reading the present disclosure, other modifications will be apparent to persons skilled in the art. Such modifications may involve other features which are already known in the field of mowers and component parts therefore and which may be used instead of or in addition to features already described herein.

1. A mower combination comprising an agricultural vehicle and a number of mowing units suitable for cutting a standing crop connected to the agricultural vehicle, including a front mowing unit and two lateral mowing units located behind and to the sides of the front mowing unit, each of the lateral mowing units having conveyor units to deposit cut crop as a swath, the mower combination further comprising:
a control unit receiving a plurality of signals, the signals representing unprocessed crop boundary data, field boundary data, and data relating to the lateral displacement of each of the lateral mowing units, the control unit being configured to receive the plurality of signals and compare the signals for the unprocessed crop boundary data, the field boundary data and the data relating to the lateral displacement of each of the conveyor units against a predetermined target set of values and to adjust the lateral displacement of at least one conveyor unit based on the comparison to taper the swath in a predetermined manner when commencing or concluding depositing the cut crop as the swath.

2. The mower combination according to claim 1, wherein the signals representing unprocessed crop boundary data are provided by one or more sensors located on the front mowing unit or the agricultural vehicle.

3. The mower combination according to claim 1, wherein the signals representing unprocessed crop boundary data are provided by one or more sensors located on the lateral mowing units.

4. The mower combination of claim 1, wherein the sensors comprise optical sensors, or GPS apparatus.

5. The mower combination of claim 1, wherein the control unit receives signals representing aspects of the agricultural vehicle.

6. The mower combination according to claim 5, wherein the control unit receives signals corresponding to an orientation of a longitudinal axis of the agricultural vehicle and/or a speed of the agricultural vehicle.

7. A computer implemented method comprising:
a control unit receiving a plurality of signals, the signals representing unprocessed crop boundary data, field boundary data, and data relating to a lateral displacement of each of two lateral mowing units;
the control unit comparing the received signals for the unprocessed crop boundary data, the field boundary data and the data relating to the lateral displacement of at least one of the lateral mowing units against a predetermined set of target values and adjusting the lateral displacement of the at least one lateral mowing unit based on the comparison.

8. A computer readable program comprising instructions that cause at least one processor to implement the method of claim 7.
